(19) United States
(12) Patent Application Publication
(10) Pub. No.: US 2002/0067125 A1
(43) Pub. Date: Jun. 6, 2002

(54) Highly visible and attractive display device

(75) Inventors: Kenji Nogaki, Tokyo (JP); Terukatsu Uchida, Tokyo (JP); Yoshiyasu Ishiyama, Tokyo (JP)

Correspondence Address: MASON & ASSOCIATES, PA, 17757 US HWY 19 N., SUITE 500, CLEARWATER, FL, 33764, US

(73) Assignee: Yugen Kaisha Lefleuve and Yugen Kaisha Picapo Corporation

(21) Appl. No.: 09/870,250

(22) Filed: May 30, 2001

(30) Foreign Application Priority Data
Dec. 2, 2000 (JP) 2000-403802

(51) Int. Cl. H05B 33/14

(52) U.S. Cl. 313/510

(57) ABSTRACT

A luminous film layer is deposited on the upper face of a transparent electrode composed of a synthetic resin film material, and is divided into insulating blocks in accordance with various patterns, or to provide individual light colors. A dielectric film layer is laminated on the upper face of the luminous film layer, and reverse electrodes, corresponding to the insulating blocks of the luminous film layer, are formed thereon. The resultant structure is then sealed by the application of a transparent synthetic resin film material, which serves as an outer protective layer, and an electroluminescence display plate is obtained. The transparent electrode and the reverse electrodes are collectively connected to an externally positioned connection socket, and a current is supplied by the connection socket to a controller that in turn supplies a variety of conductive patterns to the electrodes.

### BACKGROUND OF THE INVENTION

1. Field of the Invention

The present invention relates to a superior, highly visible and extremely attractive display device for the dissemination of shopping information, inside a retail outlet, such as a shopping center, wherein great numbers and varieties of consumer goods are exhibited for sale, to attract the attention of shoppers to specific items and encourage selective purchasing; a display device to be fastened to outdoor leisure clothing, such as for climbing or fishing, in order to assist in identification or to act as a visual aid in an emergency or when a search is mounted at the scene of a disaster; or as a display device that when fastened to clothes, hat or bag people can express or demonstrate themselves exuberantly.

2. Description of Related Art

Recently, not only for consumable but also for durable goods, huge shopping facilities, such as the supermarkets, department stores, shopping centers and specialty stores have been most frequented by shoppers today.

Since extremely large numbers and varieties of consumable and durable goods are displayed in these large retail outlets, colorful and attractively designed wrappings are used to package the items they offer for sale, and eye-catching, product information tags and labels are attached to the packages to quickly attract the attention and the interest of shoppers.

However, as a consequence of current conditions, whereunder enormous amounts and varieties of consumable and durable goods must be displayed in close-packed proximity, efforts taken to provide visual appeal, by using distinctive, carefully selected colors and designs for packages and their attached tags and labels, are rendered immaterial under the harsh illumination provided by racks of fluorescent lamps, all the colors and shapes seem to coalesce into indistinguishable blurs of colored, reflected light. And since the light colors reflected contribute to an erroneous visual clumping together and identification of unrelated merchandise, sales visibility for individual products is quite low.

In addition, while shoppers may circulate throughout large establishments, arbitrarily picking and choosing articles to purchase, displays of consumable and durable goods are fixed, and accordingly, colored reflected light, which conceivably could be used to attract shoppers, has no noticeable effect, and the movement of stock remains dependant on the whims of the public.

Also, an increasing number of people have recently become interested in outdoor leisure activities, climbing, hiking, fishing and sailing, and their participation in associated outings has tended to continue into the night, even unto the following morning, or for several days. Thus, because of drastic weather changes or nighttime activities, numerous opportunities exist for the occurrence of accidents and disasters in which participants go missing, are injured or die.

In these circumstances, the difficulties inherent in locating and rescuing victims are immense when incidents occur in remote, not easily accessed locations. In such cases, even when many rescue parties are dispatched, because of the vast distances to be covered and the more or less primeval conditions in the search areas, it is almost impossible to find victims at night or in bad weather even when searchlights are employed.

As a measure to improve the chances that victims in wilderness areas will be found, strips of optical, recursive reflection tape or fluorescent reflection tape are attached to clothes, hats or shoes worn for outdoor, leisure pursuits. However, reflective tape can not be visually distinguished until struck by a strong light beam emitted by a source such as a searchlight or a headlight. So while such tape may be quite effective and useful immediately adjacent to roads along which cars may travel, it is rather impractical in heavily forested or mountainous regions, especially at night or when bad weather conditions prevail.

Further, since members of the younger generation have so wholeheartedly adopted the accouterments with which to express their newfound individualism, and since the social environment to which they are attracted is active, day and night, young people tend to wear unconventional, uniquely colored and designed clothing and accessories to exuberantly express and demonstrate themselves.

However, their attire and accessories are designed only for daytime wear, and after sunset or at night, to express themselves they must resort to using the light produced by point or linear luminous elements, such as chemical lights or LED light emission pens, whose light emission properties are exhausted within only a short time.

To resolve the shortcomings enumerated here, through constant study, during which the emission of electroluminescence was focused on, the present inventors sought a material that could be used to fabricate an extremely thin emission source that, upon the application of a low voltage at low power, would emit light at a high luminance level across the entire plane of its surface.

Currently electroluminescence is used for backlighting, for nighttime illumination, or for plane displays for various types of devices, and may roughly be sorted into dispersive electroluminescence and thin-film electroluminescence.

As is shown in FIG. 5, according to the structure of a conventional dispersive electroluminescent construct applied for the invention, a transparent electrode B is deposited on the upper face of a glass substrate A, for maintaining the overall shape. Then, using a dielectric paste binder in which fluorescent powder C has been dispersed, screen printing is employed to deposit an approximately 30 to 50 μm thick luminous film layer D on the upper face of the transparent electrode B. Finally, a dielectric film layer E is deposited on the upper face of the luminous film layer D, and an aluminum film reverse electrode F is deposited on the upper face of the layer E.

The present inventors further studied electroluminescence, and found that when for this invention the glass substrate, which maintains the shape, is used as a small display device, such as a POP advertisement display device, that is installed or mounted in a small space wherein a large amount of various types of consumable and durable goods are arranged, the other commodities, or their packaging, may be damaged. Further, the present inventors found that when such a display device is attached to clothing it may be broken and injure the wearer if he or she hits something or somebody, or falls down.

The present inventors were enabled to provide the present invention by investigating the following matters:

a transparent electrode and the shape holding function can be maintained by coating one side of a transparent, flexible, durable synthetic resin film material with a transparent conductive film; since a binder of dielectric paste wherein fluorescent powder is dispersed is employed when a luminous film layer is deposited using screen printing, a pattern or a design can be divided as needed into insulating blocks, and the luminance film layer can be formed using a binder that emits a differently colored light for each insulating block; and reverse electrodes, which correspond in shape and size to the insulating blocks of the luminous film layer, are arranged on the upper face of the luminance film layer via a dielectric film layer, and a current flows across a predetermined pattern between the reverse electrodes and the transparent electrode.

### SUMMARY OF THE INVENTION

The present invention provides an extremely light and thin display device that provides noticeably superior visibility and attractiveness, that can be mounted or securely attached to any object, and that, using various colors and a variety of patterns or designs, becomes luminous when the intensity of the luminescence emitted is high.

The present invention also provides a display device to which an easily detachable engagement tool (or means for detachable engagement) is added at a desired location.

To achieve the above objectives, the technical means for the invention comprises:

an electroluminescence display plate, wherefor a transparent electrode is provided by coating with a transparent conductive film one side of a transparent, flexible, durable synthetic resin film material, screen printing is used to deposit a binder, provided by dispersing fluorescent powder in a dielectric paste, to a predetermined depth on the upper face of the transparent electrode, a pattern or a design is appropriately employed to divide into insulating blocks a luminous film layer, which is so formed that the insulating blocks emit differently colored lights, a dielectric film layer having a predetermined thickness is deposited on the upper face of the luminous film layer, reverse electrodes are arranged on the upper face of the dielectric film layer so as to correspond in shape and size with the insulating blocks of the luminous film layer, and a transparent synthetic resin film is applied to seal all surfaces of the resultant structure;

a connection socket, provided separate from the electroluminescence display plate, whereat a terminal that is connected to the reverse electrodes, to supply current to the insulating blocks, and a terminal connected to the transparent electrode are merged; and

a controller, for controlling an alternating-current or direct current power source for supplying a current, in a predetermined current pattern, to the transparent electrode and the reverse electrodes, the arrangement of which corresponds to the shapes and sizes of the insulating blocks of the luminous film layer.

In addition, in accordance with the technical means of the invention, Velcro, an adhesive tape or another appropriate engagement tool or means for detachable engagement on an object is attached at an appropriate location on the reverse face of the electroluminescence display plate.

To provide the above described configuration, the present invention performs the following operations. That is, instead of employing a glass substrate to maintain the shape, to form a transparent electrode the transparent conductive film is used to coat one side of the transparent, flexible, durable synthetic resin film material. Further, screen printing is employed to deposit a binder, obtained by dispersing fluorescent powder in a dielectric paste, to a predetermined depth on the upper face of the transparent electrode. A pattern or a design is then appropriately employed to divide into insulating blocks a luminous film layer, which is so formed that the insulating blocks emit differently colored lights. Following this, a dielectric film layer having a predetermined thickness is deposited on the upper face of the luminous film layer, and reverse electrodes are arranged on its upper face so as to correspond to the shapes and sizes of the insulating blocks of the luminous film layer. Finally, a transparent synthetic resin film is applied to all surfaces to seal the resultant structure. Therefore, since the electroluminescence display device that is obtained is extremely light and thin, and can be freely bent, it can be securely fixed to a surface, even to a curved face, and is protected from damage from external impact because of its flexibility. Further, since water and dust are prevented from entering the display device and no electric problems due to light emission occur, and especially because the fluorescent powder, which if unprotected is susceptible to the destructive effects of ultraviolet rays, is shielded by the synthetic resin film sealing the outer surfaces of the display device, stable luminescence can be obtained for an extended period of time.

Further, since the luminous film layer is divided into insulating blocks in accordance with the pattern or design, and since the insulating blocks are luminous and emit differently colored lights, a current can be supplied to individual insulating blocks, or to an appropriate number of them at the same time, by controlling a conductive pattern, so that variously colored lights can be used to display patterns or designs at a high luminescent level. Therefore, the display device presents a highly visible and attractive appearance, because of the illusion of movement provided by varicolored patterns and designs.

In addition, to supply a current to the electroluminescence display plate, since a terminal connected to the reverse electrodes to supply a current to the insulating blocks, and a terminal connected to the transparent electrode merge at a socket that is located outside the electroluminescence display plate, or since an appropriate alternating current or a direct current is supplied at the same time to individual insulating blocks, or to an appropriate number of them, in consonance with a predetermined pattern, the output terminal of a controller need only be connected to the connection socket to provide a luminous display that is superior in visibility and attractiveness.

Other objectives, features and advantages of the invention will become obvious during the course of the following description, given while referring to the accompanying drawings.

### BRIEF DESCRIPTION OF THE DRAWINGS

FIG. 1 is a cross-sectional view of an electroluminescence display plate according to the present invention;

FIG. 2 is an explanatory diagram for a case wherein the display device of the invention is used as a POP display device;

FIG. 3 is a diagram for explaining a controller for driving the display device of the invention;

FIG. 4 is a diagram for explaining a luminous display using the display device of the invention; and

FIG. 5 is a diagram for explaining a conventional electroluminescence substrate.

### DETAILED DESCRIPTION OF THE PREFERRED EMBODIMENT

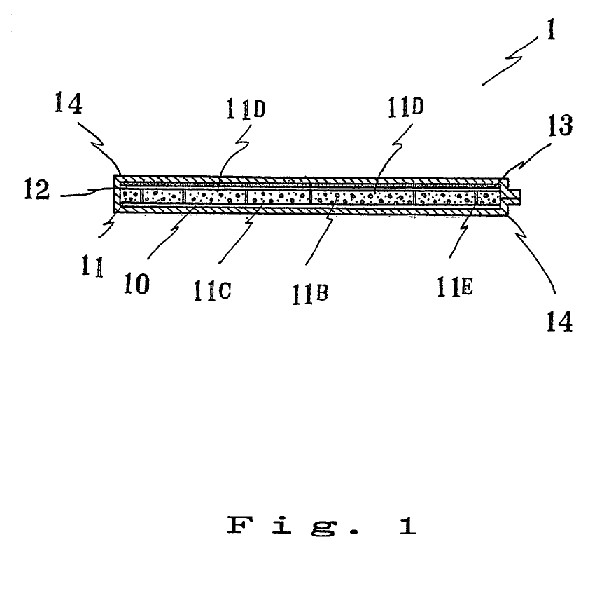

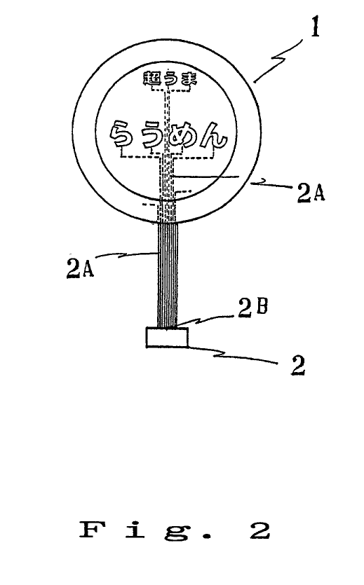

The preferred embodiment of the present invention will be explained in detail while referring to the accompanying drawings. FIG. 1 is an enlarged cross-sectional view of an electroluminescence display plate 1. Since it is preferable that a transparent electrode be formed of a transparent, flexible and durable material, a synthetic resin film material, such as polycarbonate film, polyester film, polyamido film or cellose triacetate, can be employed. A thickness of about 0.1 to 0.5 mm is preferable for a device having comparatively large dimensions, such as a POP advertising display device, while a thickness of 0.07 to 0.1 mm is preferable for a small device, such as a badge to be attached to clothes, a hat or a bag, because the device must be flexible enough to provide a margin of safety in the event a wearer collides with something or trips and falls.

A transparent conductive layer is applied to one side, or more accurately, the upper face of the synthetic resin film. This transparent conductive layer is composed of a transparent synthetic resin coating material that includes, as a conductive element, tin oxide (SnO₂), zinc sulfide (ZnS), or a zinc sulfide and indium oxide compound (ZnS—InO₂). A synthetic resin coating material must be selected that will adhere well to the synthetic resin film material that is used.

On the upper face of the thus formed transparent electrode 10, screen printing is used to deposit a luminous film layer 11 having a predetermined thickness. A binder 11C, a dielectric paste wherein fluorescent powder 11B is dispersed that becomes luminous and emits a predetermined color, is employed to form the luminous film layer 11. The general thickness of the luminous film layer 11 is about 30 to 100 μm.

In this case, the specific dielectric paste used can be a cyanoethyl resin adhesive. The fluorescent powder 11B elements that are suitable for specific light colors are, for blue light having a luminous length of 508 nm, a compound of strontium sulfide (SrS) and selenium (Ce); for green light having a luminous length of 545 nm, a compound of zinc sulfide (ZnS) and terbium (Tb), or a donor impurity such as fluorine (F) or oxygen (O); and for red light having a luminous length of 650 nm, a compound of zinc sulfide (ZnS) and samarium (Sm), or a donor impurity such as chlorine (Cl). Since a fluorescent powder having a small particle size is preferable because of the dispersion and light emission, generally a florescent powder is employed that has particles of approximately 0.5 to 5 μm.

Further, when as the result of the receipt of a current that provides an appropriate conductive pattern, a variety of patterns or designs are displayed using variously colored lights, individually or in arbitrary combinations, visibility can be improved by increasing the luminance level used for the colored lights, and attractiveness can be provided by animating the display. Thus, for the formation of the luminous film layer 11, it is important that it be divided into insulating blocks in accordance with the pattern and the design or the background. Example proposed means for defining insulating blocks 11D is a method whereby the insulating blocks 11D are defined by providing insulating gaps 11E of about 10 to 30 μm, or a method whereby portions corresponding to the insulating gaps 11E are formed by using a non-luminous film.

On the upper face of the luminous film layer 11, a dielectric film layer 12 is laminated that ensures a stable light will be emitted by the luminous film layer when it is electrified.

In order to apply a desired electric field to the luminous film layer 11, polyester film or polyamido film, having a thickness of approximately 10 to 30 μm, may be employed for the dielectric film layer 12.

Furthermore, on the upper face of the dielectric film layer 12 reverse electrodes 13 are deposited in order to effectively apply an electric field to the insulating blocks 11D of the luminous film layer 11. It is preferable that the locations and the shapes and sizes of the reverse electrodes 13 correspond to those of the insulating blocks 11D of the luminous film layer 11, so that the individual insulating blocks 11D can be independently activated and become luminous upon the application of an electric field. Generally, an aluminum metal film is employed for the reverse electrodes 13.

As an outer protective layer 14, a transparent synthetic resin film is applied that covers the entire outer surface of the structure wherein the transparent electrode 10, the luminous film layer 11, the dielectric film layer 12 and the reverse electrodes 13 are laminated, in the named order, so that the laminated structure is protected from external impact, water and dust are prevented from entering, and it is possible for a stable luminous display to be provided for an extended period of time. As a result, the electroluminescence display plate 1 is obtained.

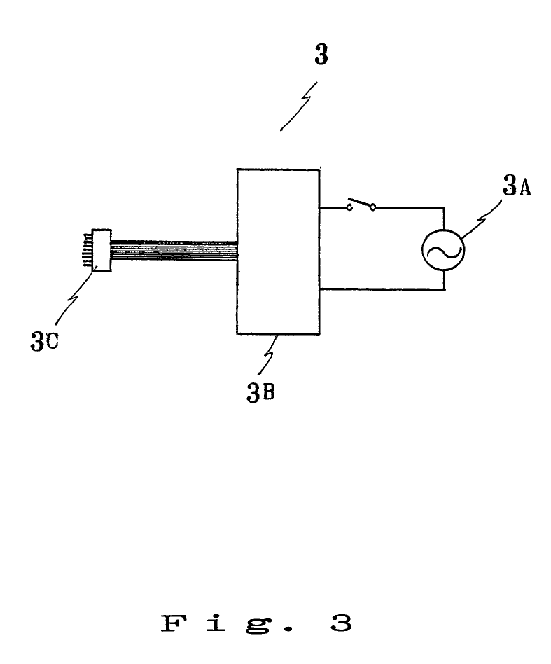

For the deposition of the outer protective layer 14, as is shown in FIG. 2, connection lines 2A for a terminal 2B are connected to the transparent electrode 10 and the reverse electrodes 13 corresponding to the insulating blocks 11D, and the terminal 2B is connected to an outside connection socket 2.

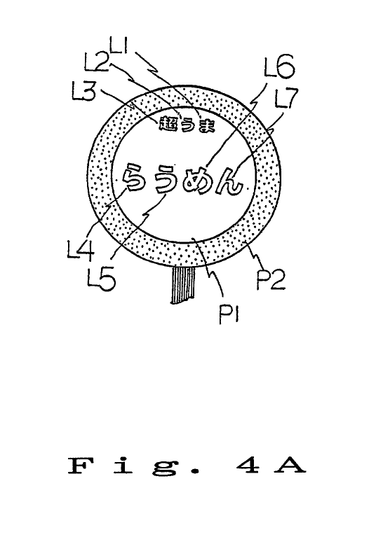

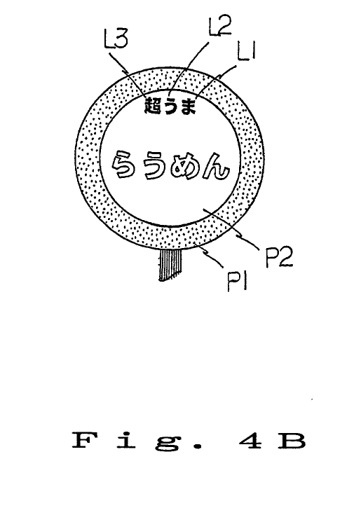

FIG. 3 is a diagram for explaining a controller 3 for the invention. An alternating-current power source or a direct-current power source can be employed as a power source 3A. An indoor power source obtained by voltage reduction is convenient for usage inside a store, while a small battery can be employed when the electroluminescence display plate 1 is transported while attached to clothes or hats.

A controller 3B is located between the power source 3A and a connection plug 3C, so that a current conforming to various conductive patterns is supplied to the reverse electrodes 13 that are arranged so they correspond to the insulating blocks 11D that are defined in accordance with the pattern, the design or the colored lights. No special restrictions are placed on the controller 3B, and an assembly consisting of a semiconductor in which a desired conductive pattern is stored is satisfactory. The power source 3A, which is set to provide a predetermined conductive pattern, is connected to the socket 2 by the connection plug 3C, and supplies a current to provide a luminous display.

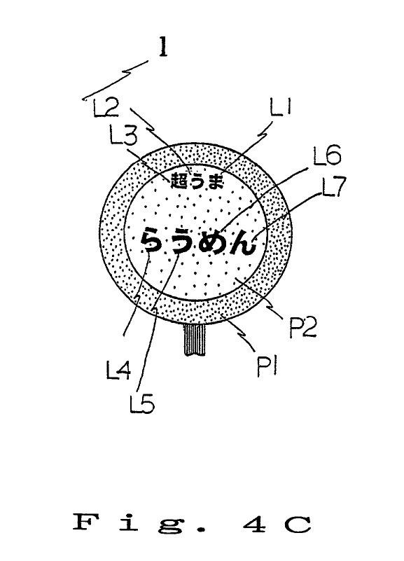

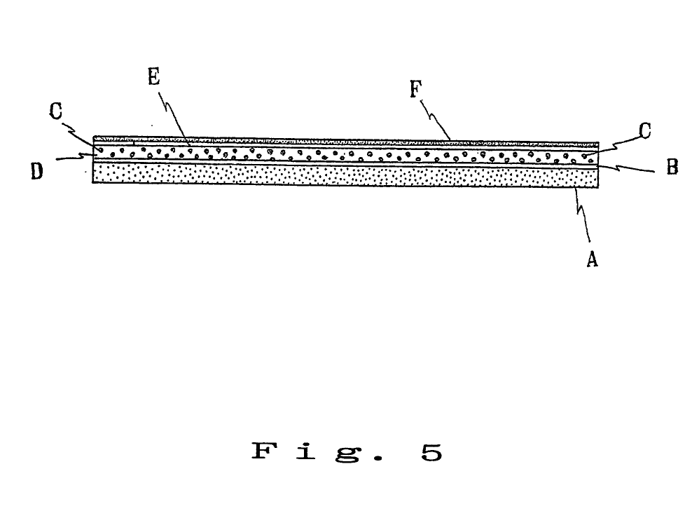

FIGS. 4A to 4C are diagrams showing luminous displays obtained when a current is supplied that conforms to a conductive pattern controlled by the controller 3. In FIG. 4A, a luminous display is shown wherein only block P1 of the insulating blocks lid is rendered conductive. In FIG. 4B, a luminous display is shown wherein blocks P1, L1, L2 and L3 are rendered conductive. And in FIG. 4C, a luminous display is shown wherein blocks P1 and P2 and L1 to L7 are rendered conductive.

Further, since the display device of the invention can be mounted in a large variety of locations or attached to many different objects, such as shelves and clothes or hats, an engagement tool or means for detachable engagement on an object, such as Velcro or adhesive tape, that is appropriate for the attachment is mounted on the reverse face of the electroluminescence display plate 1.

As is described above, according to the invention, the luminous film layer, which is deposited on the upper face of the transparent electrode composed of a transparent synthetic resin film, is divided into insulating blocks in accordance with a pattern or design, or individual luminous light colors. Then, after the dielectric film layer is deposited thereon, the reverse electrodes are laminated at locations corresponding to those of the insulating blocks in the luminous film layer, so that the insulating blocks can independently be rendered luminous. Finally, the resultant structure is sealed with a transparent synthetic resin film, to provide an electroluminescence display plate that is extremely light, thin and flexible. Furthermore, since an appropriate engagement tool is attached to the reverse face of the electroluminescence display plate, the plate can be easily mounted, not only on shelves, but also on small objects, such as clothes, hats and bags. In addition, due to its flexibility, the electroluminescence display plate is not easily damaged on impact, and will not cause injury to the body of a wearer or his or her clothes or accessories. Further, since the entry of water, damp air and dust can be completely prevented, the provision of a stable luminous display is ensured for an extended period of time.

Moreover, since only a low voltage is required to produce the electroluminescence employed for light emission and little power is consumed, maintenance costs are low. And further, since the luminous film layer is divided into insulating blocks in accordance with a pattern or design, or so as to provide individually colored lights, and current is supplied to the insulating blocks by the controller in accordance with various conductive patterns, the display plate is rendered highly visible through the combined effects provided by a high luminance level, an attractive pattern or design, and unique, contrasting, fluorescent light colors. A high level of attractiveness is also realized since the sense of movement produced by the display of various patterns and the blinking of the patterns, the design and the background stimulates the eyes of an observer. Therefore, the display device of the present invention possesses many extremely innovative characteristics, and is superior in visibility and attractiveness.

The present invention has been explained in detail by referring to the preferred embodiment. However, it is obvious that different embodiments of the present invention can be provided without departing from the spirit and scope of the invention. Thus, while the scope of the invention is limited by the claims, the invention is not limited to a specific embodiment or embodiments, and can be variously modified.

What is claimed is:

1. A display device comprising:
an electroluminescence display plate, wherefor a transparent electrode is provided by coating with a transparent conductive film one side of a transparent, flexible, durable synthetic resin film material, screen printing is used to deposit a binder, provided by dispersing fluorescent powder in a dielectric paste, to a predetermined depth on an upper face of said transparent electrode, a pattern is employed to divide into insulating blocks a luminous film layer, which is so formed that said insulating blocks emit differently colored lights, a dielectric film layer having a predetermined thickness is deposited on an upper face of said luminous film layer, reverse electrodes are arranged on the upper face of said dielectric film layer so as to correspond in shape and size with said insulating blocks of said luminous film layer, and a transparent synthetic resin film is applied to seal all surfaces of the resultant structure;
a connection socket, provided separate from said electroluminescence display plate, whereat a terminal that is connected to said reverse electrodes, to supply current to said insulating blocks, and a terminal connected to said transparent electrode are merged; and
a controller, for controlling an alternating-current or direct current power source for supplying a current, in a predetermined current pattern, to said transparent electrode and said reverse electrodes, the arrangement of which corresponds to the shapes and sizes of said insulating blocks of said luminous film layer.

2. A display device according to claim 1, further comprising:
means for detachable engagement on an object, said means being attached at a location on a reverse face of said electroluminescence display plate.
